(19) United States
(12) Patent Application Publication
(10) Pub. No.: US 2014/0132681 A1
(43) Pub. Date: May 15, 2014

(54) RECORDING METHOD AND RECORDING MEDIUM

(71) Applicant: SEIKO EPSON CORPORATION, Tokyo (JP)

(72) Inventor: Kenichi Seguchi, Okaya-shi (JP)

(73) Assignee: SEIKO EPSON CORPORATION, Tokyo (JP)

(21) Appl. No.: 13/768,322

(22) Filed: Feb. 15, 2013

(30) Foreign Application Priority Data
Nov. 9, 2012 (JP) 2012-247808

(51) Int. Cl. B41J 11/00

(52) U.S. Cl. CPC B41J 11/0015
USPC 347/100

(57) ABSTRACT

A recording method includes discharging an ink composition containing a resin onto a recording medium having a surface temperature Tm of 40° C. or more. The recording medium includes an ink receiving layer containing a resin having a glass transition temperature Tg₂ of 15 to 55° C.

### BACKGROUND

1. Technical Field

The present invention relates to a recording method and a recording medium used for the recording method.

2. Related Art

An inkjet recording apparatus ejects an ink composition through a nozzle, thus forming images on the upper surface of a recording medium. In order to improve the quality of the images, various methods have been proposed.

For example, JP-T-2004-533945 discloses a printing method to improve image quality. In this method, a recording medium having a primer-treated surface layer is prepared, and an ink layer is formed on the surface layer by ink jet printing.

However, if the amount of ejected ink is increased to improve image quality, ink aggregation, which degrades image quality, or printing problems such as roller mark unevenness are likely to occur even in the ink jet printing disclosed in JP-T-2004-533945.

Also, if printing is performed on a transparent base material, the rub fastness of the ink coating at the surface of the printed article is not good particularly when the base material is a film or sheet of olefin, PET or any other plastic, and the drying speed of the ink is low immediately after printing. Accordingly, such a base material is provided with an ink receiving layer to increase the drying speed. Unfortunately, from the viewpoint of maintaining the transparency of the base material, the material of the ink receiving layer is limited to transparent resin. Thus, it is difficult to solve the issues of degradation in image quality resulting from ink aggregation and printing problems such as roller mark unevenness when the amount of ejected ink is increased to improve image quality.

### SUMMARY

Accordingly, an advantage of some aspects of the invention is that it provides a recording method in which ink aggregation and cracks are suppressed even if the amount of ejected ink is increased to improve image quality.

The present inventors have conducted intensive research to solve the above issues. As a result, the inventors have found that the issues can be solved by discharging an ink composition onto a recording medium having an ink receiving layer having a specific glass transition temperature Tg at a predetermined temperature.

More specifically, a recording method is provided which includes discharging an ink composition containing a resin onto a recording medium having a surface temperature Tm of 40° C. or more. The recording medium includes an ink receiving layer containing a resin having a glass transition temperature Tg₂ of 15 to 55° C.

The glass transition temperature Tg₂ may be 40 to 55° C.

The ink receiving layer may contain at least either a urethane resin or an acrylic resin.

The ink receiving layer may contain a polycarbonate-based urethane resin.

The resin in the ink composition may have a glass transition temperature Tg₁ of more than 40° C.

In the discharging of the ink composition, the glass transition temperature Tg₁ of the resin in the ink composition, the surface temperature Tm and the glass transition temperature Tg₂ of the resin in the ink receiving layer may satisfy the following relationship: Tg₁>Tm≧Tg₂.

The method may further include heating the recording medium to a temperature.

The temperature in the heating may be higher than or equal to the glass transition temperature Tg₁ of the resin in the ink composition.

The glass transition temperature Tg₁ of the resin in the ink composition may be 70 to 120° C.

The ink composition may contain at least one selected from the group consisting of 2-pyrrolidone, N,N′-dimethylpropyleneurea, 1,3-dimethylimidazolidinone, 1,2-pentanediol, 1,2-hexanediol, 1,2-heptanediol, triethylene glycol, 1,6-hexanediol, 2-methyl-2,4-pentanediol, 3-methyl-1,5-pentanediol, and 2-ethyl-1,3-hexanediol.

According to another aspect of the invention, a recording medium used in the above recording method is provided.

### BRIEF DESCRIPTION OF THE DRAWINGS

The invention will be described with reference to the accompanying drawings, wherein like numbers reference like elements.

FIG. 1 is a schematic partial sectional view of a recording apparatus used in an embodiment of the invention.

FIG. 2 is a fragmentary sectional view of a recording medium according to an embodiment of the invention.

FIG. 3 is a schematic representation illustrating the evaporation of the solvent in an ink on the surface of an ink receiving layer according to an embodiment of the invention.

FIG. 4 is a schematic representation illustrating the evaporation of the solvent in an ink on the surface of an ink receiving layer according to another embodiment of the invention.

### DESCRIPTION OF EXEMPLARY EMBODIMENTS

Embodiments of the invention will now be described with reference to the drawings. However, the invention is not limited to the disclosed embodiments, and various modifications may be made without departing from the scope and spirit of the invention. For the sake of visibility, the dimensional proportions of the layers and other members in the drawings may be varied from those in practice.

### Recording Method

In the recording method according to an embodiment, an ink composition containing a resin is discharged onto a recording medium having a surface temperature Tm of 40° C. or more. The recording medium includes an ink receiving layer containing a resin having a glass transition temperature Tg₂ of 15 to 55° C.

### Discharging of Ink Composition (First Step)

In a first step, an ink composition is discharged onto a recording medium having a surface temperature Tm of 40° C. Preferably, the surface temperature Tm is 45° C. or more. Preferably, the upper limit of the surface temperature is 70° C., and is more preferably 60° C. When the surface temperature Tm is in such a range, ink aggregation and cracks tend to be suppressed. In addition, by controlling the surface temperature Tm to a temperature lower than or equal to the above upper limit, nozzles of the head become unlikely to be damaged or degraded by heat, or to be clogged with the resin in the ink composition.

As the ink composition lands on the recording medium having a surface temperature Tm of 40° C. or more, water in the ink composition starts evaporating, and the viscosity of the ink composition is rapidly increased accordingly. Thus, it is expected that the ink composition will adhere more easily to the ink receiving layer of the recording medium. As another ink droplet lands on the recording medium, the ink droplet is mixed with previously landed ink droplets, so that aggregation or flowing of the ink composition and bleeding in the image can be suppressed. Thus, the ink composition can be precisely deposited at desired positions with a high adhesion, and consequently, the quality of images formed on the recording medium can be maintained. However, other factors may be involved in the landing precision and adhesion of the ink.

When an ink composition contains a resin, the resin in the ink composition and the resin in the ink receiving layer will be rapidly mixed with each other, so that the ink composition can easily be fixed to the ink receiving layer. In this instance, it is preferable that the glass transition temperature Tg₁ of the resin in the ink composition, the surface temperature Tm of the recording medium and the glass transition temperature Tg₂ of the resin in the ink receiving layer satisfy the following relationship (1) so that the resins can be rapidly mixed with each other. When the surface of the recording medium is heated to a temperature Tm lower than the glass transition temperature Tg₁ of the resin in the ink composition and higher than or equal to the glass transition temperature Tg₂ of the resin in the ink receiving layer, the ink receiving layer is softened, and the ink composition can be more easily fixed to the ink receiving layer accordingly. Consequently, ink aggregation can be further suppressed, and the degree of roller mark unevenness is likely to be reduced.

Tg₁>Tm≧Tg₂

### Heating of Recording Medium (Second Step)

In the recording method of an embodiment, the recording medium may be heated after the discharging of the ink composition. By heating the recording medium, the rub fastness of the ink composition on the ink receiving layer is likely to be enhanced. When the ink composition contains a resin and water, the recording medium is heated preferably to 70 to 120° C., more preferably to 80 to 90° C. By setting the heating temperature in such a range, the time taken to form an image and impart rub fastness to the image from the start of printing can be reduced, and the base material of the printed article is unlikely to be deformed by the heat.

### Recording Apparatus

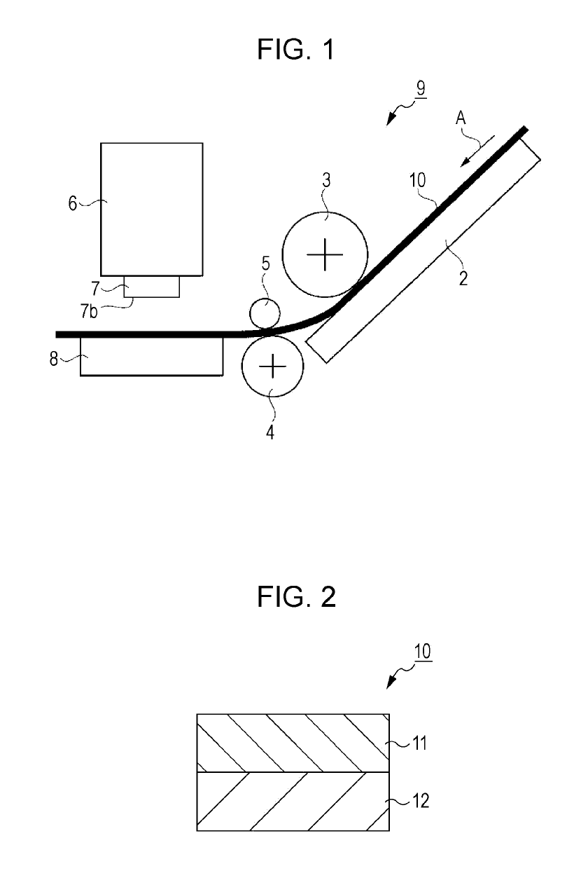

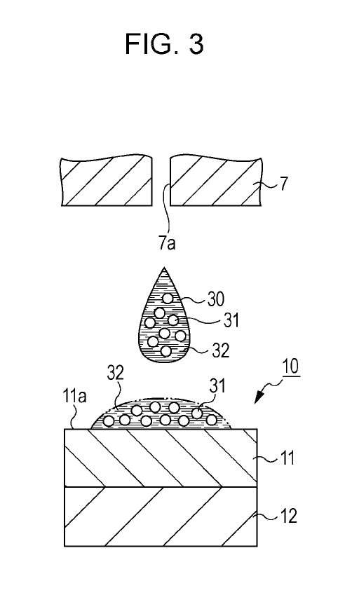

A recording apparatus that can be used in an embodiment of the invention will now be described by way of example. FIG. 1 is a schematic sectional view of a part of a recording apparatus 9 used in an embodiment of the invention. The recording apparatus 9 includes a transport mechanism including portions 2, 3, 4 and 5, a carriage 6, an ink jet head 7, and a heater 8. The portions 2, 3, 4 and 5 of the transport mechanism include rollers that transport a recording medium 10 to a position opposing a nozzle face 7b of the ink jet head 7. The carriage 6 allows the ink jet head 7 to scan in a direction substantially perpendicular to the transport direction of the recording medium 10. The ink jet head 7 has the nozzle face 7b in which a plurality of nozzles 7a (see FIG. 3), or ink discharge ports, are formed. Ink droplets are discharged through the nozzles 7a to the recording medium 10, thereby forming an image on the recording medium 10. The heater 8 heats the printing surface of the recording medium 10 from the opposite side. The heater 8 may heat the recording medium 10 from the printing surface side in another embodiment.

The operation of the recording apparatus 9 for forming an image on the recording medium 10 will now be described. First, a recording medium 10 fed to the recording apparatus 9 is taken to portions 2 and 3 of the transport mechanism, and then transported by portions 4 and 5 to the position opposing the nozzle face 7b of the ink jet head 7. Then, ink droplets are discharged onto the heated recording medium 10 from the ink jet head 7 to from an image. At this time, the recording medium 10, immediately before being subjected to image formation, is preheated with the heater 8. Then, the recording medium 10 on which an image has been formed with the ink jet head 7 is further heated and dried with the heater 8, and is ejected from the recording apparatus 9. The heater 8 may be disposed only upstream of the ink jet head 7 in the transport direction of the recording medium 10, or two or more heaters 8 may be separately disposed upstream and downstream of the ink jet head 7.

The recording apparatus 9 further includes a temperature sensor. The temperature sensor measures the surface temperature Tm of the recording medium 10. More specifically, the surface temperature can be measured with, for example, a non-contact infrared thermometer that measures temperature by receiving an energy of infrared radiation from the surface of an object, proportional to the temperature of the surface.

### Recording Medium

### Glass Transition Temperature Tg₂

The recording medium used in an embodiment of the invention will now be described. The recording medium used in the recording method according to an embodiment includes an ink receiving layer containing a resin having a glass transition temperature Tg₂ of 15 to 55° C. Preferably, the glass transition temperature Tg₂ is 40 to 55° C. When the glass transition temperature Tg₂ is in such a range, the ink composition can be more rapidly fixed to the ink receiving layer of the recording medium. Consequently, as another ink droplet lands on the recording medium, the ink droplet is mixed with previously landed ink droplets, and thus bleeding in the image can be suppressed. In addition, ink aggregation is likely to be suppressed. Furthermore, when the glass transition temperature Tg₂ is in an above-mentioned range, the degree of cracks and roller mark unevenness is likely to be reduced. Glass transition temperature (Tg) is a value measured with a dynamic viscoelasticity meter, such as a meter disclosed at http://www.tainstruments.co.jp/products/rheology/.

### Ink Receiving Layer

Preferably, the ink receiving layer contains at least either a urethane resin or an acrylic resin. The urethane resin is preferably a polycarbonate-based urethane resin. By use of such an ink receiving layer, the adhesion of the ink composition is likely to be increased. Consequently, the occurrence of ink aggregation and cracks tends to be suppressed, and the ink composition of the image is not easily decomposed by, for example, hydrolysis under high-temperature, high-humidity conditions. Accordingly, the resulting image can be resistant to heat, chemicals and weather.

The urethane resin in the ink receiving layer is not limited to polycarbonate-based urethane resins, and a polyester-based urethane resin or a polyether-based urethane resin may be used. An example of polycarbonate-based urethane resin is Urethane Emulsion Series WBR-2101 produced by Taisei Fine Chemical. Examples of polyester-based urethane resin include WBR-600U and WBR-2000U produced by Taisei Fine Chemical. Examples of polyether-based urethane resin include WBR-016U and WBR-2018 produced by Taisei Fine Chemical. These resins may be used singly or in combination.

Examples of the acrylic resin used in the ink receiving layer include 3MF series of Taisei Fin Chemical such as 3MF-309S, 3MF-320, 3MF-333, 3MF-407, 3MF-574, and 3MF-587, Acrylic Emulsion VONCOAT 40-418EF produced by DIC, and ES-960MC produced by Takamatsu Oil & Fat Co., Ltd. Among these, SE-960MC of Takamatsu Oil & Fat is advantageous. Those acrylic resins may be used singly or in combination.

### First Embodiment

FIG. 2 is a fragmentary sectional view of a recording medium according to a first embodiment. As shown in FIG. 2, the recording medium 10 includes an ink receiving layer 11 and a base layer 12. The ink receiving layer 11 is disposed on the base layer 12.

The ink receiving layer 11 may be transparent, translucent or opaque. If the ink receiving layer is opaque, the material of the ink receiving layer may be, but is not limited to, a plastic or an inorganic porous material that is prepared by binding inorganic porous particles, such as alumina or silica gel, with a binder.

If the ink receiving layer is transparent or translucent, the material of the ink receiving layer may be, but is not limited to, polyethylene (specific heat: 0.50 to 0.55 cal/K·g, density: 0.91 to 0.97 g/cm³), polypropylene (specific heat: 0.46 cal/K·g, density: 0.90 to 0.91 g/cm³), polycarbonate (specific heat: 0.30 cal/K·g, density: 1.2 g/cm³), polymethyl methacrylate (specific heat: 0.35 cal/K·g, density: 1.17 to 1.20 g/cm³), cellulose acetate (specific heat: 0.30 to 0.42 cal/K·g, density: 1.23 to 1.34 g/cm³), or styrene-butadiene-acrylonitrile copolymer (specific heat: 0.33 to 0.4 cal/K·g, density: 1.08 to 1.1 g/cm³) (reference: Kagaku Binran (Handbook of Chemistry), The Chemical Society of Japan).

The base layer 12 may be made of any material and may be transparent, translucent or opaque without particular limitation as long as it can support the ink receiving layer 11 and has a strength sufficient as a recording medium 10.

If the base material is opaque, the material of the base material may be, for example, plastic, cloth, wood, metal, or paper without particular limitation. If the base material is transparent (or translucent), the material of the base layer may be, but is not limited to, polyester-based resin, diacetate-based resin, triacetate-based resin, acrylic resin, polycarbonate-based resin, polyvinyl chloride-based resin, polyimide-based resin, cellophane, celluloid, or glass.

The thickness of the ink receiving layer 11 can be, but is not limited to, 8 to 50 μm, and preferably 15 to 40 μm. An ink receiving layer having a thickness of 8 μm or more can absorb and hold the ink, and accordingly the occurrence of cracks tends to be reduced. In addition, if the thickness of the ink receiving layer is 50 μm or less, deformation and curls after drying, resulting from shrinkage stress tend to be suppressed.

It will now be described how ink droplets 30 land and dry on the ink receiving layer 11 of the recording medium 10 of the present embodiment. FIG. 3 is a schematic representation illustrating the evaporation of a solvent 32 from the ink droplet on the ink receiving layer 11.

A droplet ejected to the recording medium 10 through the nozzles 7a of an ink jet head 7 contains pigment particles 31 and the solvent 32 in which the pigment particles 31 are dispersed.

As the ink droplet 30 of an ink composition lands on the ink receiving layer 11 of the recording medium 10, the solvent 32 in the ink droplet 30 penetrates into the ink receiving layer 11. At this time, the ink droplet 30 draws heat from the ink receiving layer 11. Consequently, the solvent 32 is evaporated or volatilized by the heat, thus removed from the ink receiving layer 11. After the solvent 32 is evaporated or volatilized, the resin and pigment particles 31 in the ink composition remain on the surface 11a of the ink receiving layer 11 and thus from an image.

From the viewpoint of rapidly evaporating the solvent 32 to form a good image, at this time, it is most efficient that the ink receiving layer 11 previously has an amount of heat required to evaporate the solvent 32 before the ink droplet 30 lands on the ink receiving layer 11.

For increasing image quality in an ink jet printing using an aqueous ink composition, the amount of ejected ink may be increased. In this instance, however, the solvent 32 in the ink droplet 30 may not evaporate sufficiently and may remain on the surface 11a of the ink receiving layer 11. Consequently, another ink droplet 30, subsequently discharged through the nozzles 7a, landing on the ink receiving layer 11 will be mixed with the undried ink on the surface 11a of the ink receiving layer 11. This causes ink aggregation and cracks that degrade image quality. The recording method of the present embodiment allows ink droplets 30 to be well fixed to the ink receiving layer 11, and thus solves the issues described above.

### Second Embodiment

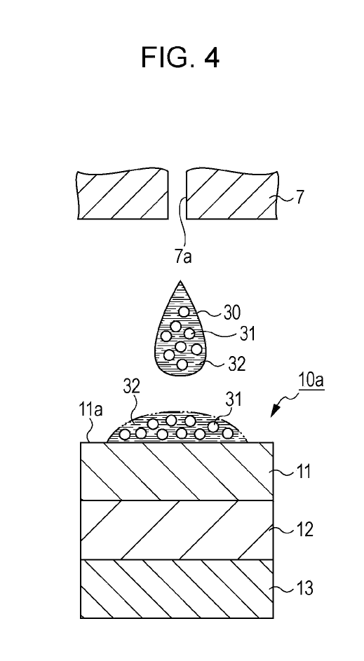

FIG. 4 shows part of the recording medium according to a second embodiment of the invention. The same parts as in the first embodiment are designated by the same reference numerals and thus description thereof is omitted. As shown in FIG. 4, the recording medium 10a includes an ink receiving layer 11, a base layer 12, and a back layer. The ink receiving layer 11 is disposed on the base layer 12, and the base layer is disposed on one surface of the back layer 13. The back layer 13 may be transparent, translucent or opaque. If the back layer is opaque, the material of the back layer may be, but is not limited to, a plastic or an inorganic porous material that is prepared by binding inorganic porous particles, such as alumina or silica gel, with a binder. If the back layer is transparent or translucent, the back layer may be, but is not limited to, polyethylene, polypropylene, polycarbonate, polymethyl methacrylate, cellulose acetate, or styrene-butadiene-acrylonitrile copolymer.

As an ink droplet 30 is ejected onto the ink receiving layer 11 of the recording medium 10a, the ink receiving layer 11, which is preheated to hold heat therein by the recording apparatus 9, comes into contact with the solvent 32 in the ink droplet 30, and the heat of the ink receiving layer 32 is conducted to the solvent 32 and thus accelerates the evaporation of the solvent 32. Consequently, pigment particles 31 remain on and are fixed to the surface 11a of the ink receiving layer 11, thus forming an image. By providing the recording medium 10a with the back layer 13, the thickness and rigidity of the recording medium 10a are increased, and the recording apparatus 9 can smoothly transport the recording medium. Consequently, paper jam and rubbing with the head can be prevented.

### Method for Manufacturing Recording Medium

The method for manufacturing the recording medium is not particularly limited as long as the ink receiving layer can be formed. For example, the recording medium can be manufactured by applying an acrylic-urethane aqueous resin emulsion to a base material and drying the coating of the emulsion by heat. The acrylic-urethane aqueous resin emulsion may be prepared in a process as disclosed in Japanese Patent No. 3661047. In the process, for example, an aqueous dispersion is prepared in which a neutralized carboxylic urethane prepolymer having an isocyanate group at the end thereof and an acrylic monomer are dispersed in water. The acrylic monomer in the dispersion is polymerized, and then the chain of the urethane prepolymer is extended.

### Ink Composition

The ink composition containing a resin, used in the recording method of the present embodiment will now be described in detail. The ink composition is preferably aqueous. More specifically, the ink composition preferably contains a resin compatible with the resin in the ink receiving layer. In this instance, the resin in the ink composition will be sufficiently mixed with the resin in the ink receiving layer, and consequently, the ink composition is more likely to be fixed to the ink receiving layer.

More preferably, the ink composition further contains water and a solvent dissolving the resin. As such an ink composition, containing the resin, water and a solvent, lands on a recording medium having a surface temperature Tm of 40° or more, the water is evaporated and the solvent is thickened. Consequently, the resin in the ink composition is dissolved in the thickened solvent. Subsequently, part of the dissolved resin is mixed with the ink receiving layer, so that the ink composition is sufficiently fixed to the ink receiving layer. Thus, another ink droplet subsequently deposited on the recording medium is mixed with previously landed ink droplets, so that aggregation or flowing of the ink composition and bleeding in the image can be suppressed effectively. Consequently, the quality of the image formed on the recording medium can be maintained better, and higher rub fastness and adhesion of the image can be ensured. However, other factors may be involved in the rub fastness and adhesion.

In this instance, as the resin in the ink composition and the resin in the ink receiving layer are more easily mixed with each other, the bound portion between the resin molecules increases when the resins are solidified. Thus, higher adhesion is given between the ink composition and the ink receiving layer. A printed article is produced by mixing the resin in the ink composition and the resin in the ink receiving layer. The glass transition temperature Tg of the mixed portion probably depends on the proportion of these resins in the mixed portion.

If the recording medium is heated after the discharging of the ink composition, the solvent is further evaporated by this heating. Consequently, the resin is cured to form a thin film, and the rub fastness is likely to increase further.

From the viewpoint of ensuring this effect and resulting in good effect, the resin in the ink composition is preferably a thermoplastic resin insoluble or difficult to dissolve in water, and the solvent preferably contains nitrogen. More preferably, the ink composition further contains a solvent having a low surface tension in addition to the nitrogen-containing solvent. The nitrogen-containing solvent can be selected from the group consisting of 2-pyrrolidone, N,N′-dimethylpropyleneurea and 1,3-dimethylimidazolidinone. More specifically, a preferred example of the ink composition may contain water, a water-insoluble coloring agent, a solvent having a low surface tension, a surfactant, a nitrogen-containing solvent selected from among 2-pyrrolidone, N,N′-dimethylpropyleneurea and 1,3-dimethylimidazolidinone, and water-insoluble thermoplastic resin particles. Such an ink composition is likely to form high-quality images having higher rub fastness.

### Thermoplastic Resin Particle

Exemplary resins of the thermoplastic resin particles include, but are not limited to, homopolymers and copolymers of urethane resin, acrylic acid, acrylic ester, methacrylic acid, methacrylic ester, acrylonitrile, cyanoacrylate, acrylamide, olefin, styrene, vinyl acetate, vinyl chloride, vinyl alcohol, vinyl ether, vinyl pyrrolidone, vinyl pyridine, vinyl carbazole, vinyl imidazole and vinylidene chloride, fluororesins, and natural resins. If a copolymer is used, the copolymer may be a random copolymer, a block copolymer, an alternating copolymer, or a graft copolymer. If a thermoplastic resin other than urethane resins is used, acrylic resins or styrene-acrylic acid copolymer-based resins are suitable. These resins have high hardnesses and are difficult to scratch or flaw. If the thermoplastic resin particles are prepared from a urethane resin and another resin in combination, the particles are preferably in a core-shell form, and the urethane resin forms shells of the particles while the other resin forms cores of the particles.

The thermoplastic resin particles containing a urethane resin may be prepared from a known material by a known method. For example, thermoplastic resin particles disclosed in JP-A-8-60063 or JP-A-6-329985 may be used. Commercially available thermoplastic resin particles may be used, such as ACRIT WEM-202U, WEM-030U, WEM-321U, WEM-306U, WEM-162, WBR-183U, WBR-601U, WBR-401U, 3DR-057, 3DR-829 and 3DR-828 (each produced by Taisei Fine Chemical); and AQUABRID AU-304 (produced by Daicel).

The solid content of the thermoplastic resin particles is preferably in the range of 1% to 8% by mass to the total mass of the ink composition. If the thermoplastic resin particles contain a urethane resin, the solid content of such thermoplastic resin particles is preferably in the range of 1.5% to 5% by mass relative to the total mass of the ink composition. When the thermoplastic resin particle content is 1% by mass or more, the resulting image is likely to be more tightly fixed to the recording medium. In addition, when the thermoplastic resin particle content in the ink composition is 8% by mass or less, the ink composition is likely to be stably discharged, so that the nozzles of the ink jet head can be prevented from being clogged.

### Glass Transition Temperature Tg₁

The resin in the ink composition has a glass transition temperature Tg₁ of preferably more than 40° C., more preferably 70 to 120° C., still more preferably 80 to 110° C. When the glass transition temperature Tg₁ is in such a range, the ink composition is likely to exhibit a higher compatibility with the ink receiving layer, and the rub fastness of printed images tends to increase. If the ink composition contains two or more resins, glass transition temperature Tg₁ is a measurement of the glass transition temperature of the mixture of the resins. Glass transition temperature (Tg) is a value measured with a dynamic viscoelasticity meter, such as a meter disclosed at http://www.tainstruments.co.jp/products/rheology/.

### Nitrogen-containing Organic Solvent

The ink composition preferably contains one or more solvents selected from the group consisting of 2-pyrrolidone, N,N′-dimethylpropyleneurea and 1,3-dimethylimidazolidinone. These nitrogen-containing organic solvents act as suitable solvents or softening agents of polyvinyl chloride, which may be the material of the thermoplastic resin particles or a nonabsorbent recording medium.

The above nitrogen-containing organic solvents, which have boiling points of 240 to 250° C., can be concentrated without volatilizing in the first step of discharging the ink composition. Then, the nitrogen-containing organic solvent concentrated in the residue of the ink composition on the recording medium can dissolve at least part of the thermoplastic resin particles. The dissolved thermoplastic resin helps the solidified ink mainly containing a coloring agent form a coating on the ink receiving layer of the recording medium, so that the coating can be fixed to the recording medium. The thermoplastic resin dissolved in the nitrogen-containing organic solvent can be more easily mixed with the resin in the ink receiving layer. Consequently, ink aggregation, cracks, and roller mark unevenness tend to be suppressed, and, in addition, rub fastness is likely to be enhanced.

The nitrogen-containing organic solvent content is preferably in the range of 3% to 15% by mass, more preferably 5% to 10% by mass, relative to the total mass of the ink composition. When the nitrogen-containing organic solvent content is 3% by mass or more, the image (ink composition) is likely to be more tightly solidified and fixed to the recording medium. When the nitrogen-containing organic solvent content is 15% by mass or less, the ink composition is likely to be evaporated or volatilized and rapidly dried.

Solvent Having Low surface Tension

Examples of the solvent having a low surface tension include, but are not limited to, 1,2-alkanediols, such as 1,2-pentanediol, 1,2-hexanediol, and 1,2-heptanediol. Among these, 1,2-hexanediol, which is a 1,2-alkanediol having a carbon number of 6 and having a boiling point of 223° C., has a slightly lower boiling point than the nitrogen-containing organic solvent. Therefore, 1,2-hexanediol will remain in the ink until just before the ink is completely dried, after the water has been evaporated. Thus, the ink composition containing 1,2-hexanediol can wet uniformly the surface of a recording medium whose recording surface is made of a nonabsorbent plastic material, so that the degree of bleeding in the resulting image can be reduced.

If 1,2-hexanediol is used as the solvent having a low surface tension, its content is preferably 3% by mass or more relative to the total mass of the ink composition, from the viewpoint of achieving a sufficient wettability of the ink composition to an ink-nonabsorbent or ink-low-absorbent recording medium. Also, from the viewpoint of rapidly drying the ink composition, the 1,2-hexanediol content is preferably 8% by mass or less.

The ink composition may further contain another solvent having a moisturizing function or having a low surface tension. Examples of such a solvent include, but are not limited to, water-soluble solvents, such as ethylene glycol monobutyl ether, diethylene glycol mono-n-propyl ether, ethylene glycol monoisopropyl ether, diethylene glycol monoisopropyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol monoisopropyl ether, propylene glycol mono-n-butyl ether, dipropylene glycol mono-n-butyl ether, dipropylene glycol mono-n-propyl ether, dipropylene glycol monoisopropyl ether, methanol, ethanol, n-propyl alcohol, isopropyl alcohol, 2,2-dimethyl-1-propanol, n-butanol, 2-butanol, tert-butanol, isobutanol, 2-methyl-1-butanol, 3-methyl-1-butanol, 3-methyl-2-butanol, n-pentanol, 2-pentanol, 3-pentanol, tert-pentanol, N-methyl-2-pyrrolidone, tetramethylurea, dimethyl sulfoxide, 2-pyrrolidone, 1,3-dimethyl-imidazolidinone, and N,N′-dimethylpropyleneurea.

The ink composition may further contain a wetting agent. Examples of the wetting agent include, but are not limited to, polyhydric alcohols, such as ethylene glycol, diethylene glycol, triethylene glycol, polyethylene glycol, propylene glycol, dipropylene glycol, tripropylene glycol, polypropylene glycol, diethylene glycol, triethylene glycol, dipropylene glycol, tripropylene glycol, thiodiglycol, hexylene glycol, 1,3-propanediol, 1,3-butanediol, 2,3-butanediol, 1,4-butanediol, 3-methyl-1,3-butanediol, 1,5-pentanediol, 1,6-hexanediol, tetraethylene glycol, 1,6-hexanediol, 2-methyl-2,4-pentanediol, 3-methyl-1,5-pentanediol, 2-ethyl-1,3-hexanediol, thiodiglycol, glycerol, 1,2,6-hexanetriol, 1,2,4-butanetriol, 1,2,3-butanetriol, and 3-methyl-1,3,5-pentanetriol. Among these, polyhydric alcohols such as alkylene glycols and glycerol are suitable. These wetting agents may be used singly or in combination.

The content of the moisturizing agent content and wetting agent in the ink composition may be, but is not limited to, 0% to 40% by mass, and preferably 2% to 30% by mass, more preferably 5% to 25% by mass.

### Coloring Agent

The coloring agent may be a water-insoluble dye or pigment, and preferably a pigment. Pigments are not only insoluble or difficult to dissolve in water, but are also not easily discolored by light or gases. Accordingly, recorded articles prepared by printing with an ink composition containing a pigment are resistant to gases, weather and light, and thus exhibit high storage stability. The pigment can be an organic or inorganic pigment used in known ink jet recording ink compositions.

Exemplary inorganic pigments include titanium oxide, iron oxide, and carbon blacks produced by known methods, such as a contact method, a furnace method, and a thermal method.

Exemplary organic pigments include azo pigments, such as azo lake, insoluble azo pigments, condensed azo pigments, and chelate azo pigments; polycyclic pigments, such as phthalocyanine pigments, perylene pigments, perinone pigments, anthraquinone pigments, quinacridone pigments, dioxazine pigments, thioindigo pigments, isoindolinone pigments, and quinophthalone pigments; dye chelates, such as basic dye chelates and acid dye chelates; nitro pigments; nitroso pigments; and aniline black. Among these, pigments compatible with water are advantageously used.

Pigments that can be used for black inks include, but are not limited to, carbon blacks (C.I. Pigment Black 7), such as furnace black, lampblack, acetylene black, and channel black; metal oxides, such as copper oxide, iron oxide (C.I. Pigment Black 11), and titanium oxide; and organic pigments, such as aniline black (C.I. Pigment Black 1).

Carbon blacks available from Mitsubishi Chemical may be suitable, such as No. 2300, 900, MCF 88, No. 20B, No. 33, No. 40, No. 45, No. 52, MA 7, MA 8, MA 100, and No. 2200B. Carbon blacks available from Degussa may also be used, such as Color Blacks FW 1, FW 2, FW 2V, FW 18, FW 200, S 150, S 160 and S 170, Pritex 35, U, V and 140U, and Special Blacks 6, 5, 4A and 4. Carbon blacks available from Columbia Carbon include Conductex SC, and Ravens 1255, 5750, 5250, 5000, 3500, 1255 and 700. Carbon blacks available from Cabot include Regals 400R, 330R and 660R, Mogul L, Monarchs 700, 800, 880, 900, 1000, 1100, 1300 and 400, and Elftex 12.

Pigments that can be used for color inks include C.I. Pigment Yellows 1 (fast yellow G), 3, 12 (disazo yellow AAA), 13, 14, 17, 23, 24, 34, 35, 37, 42 (yellow iron oxide), 53, 55, 74, 81, 83 (disazo yellow HR), 95, 97, 98, 100, 101, 104, 108, 109, 110, 117, 120, 138, 150, 151, 154, 155, 180, 185, and 213; C.I. Pigment Reds 1, 2, 3, 5, 17, 22 (brilliant fast scarlet), 23, 31, 38, 48:2 (permanent red 2B (Ba)), 48:2 (permanent red 2B (Ca)), 48:3 permanent red 2B (Sr)), 48:4 (permanent red 2B (Mn)), 49:1, 52:2, 53:1, 57:1 (brilliant carmine 6B), 60:1, 63:1, 63:2, 64:1, 81 (rhodamine 6G lake), 83, 88, 92, 101 (colcothar), 104, 105, 106, 108 (cadmium red), 112, 114, 122 (quinacridone magenta), 123, 146, 149, 166, 168, 170, and 172; Pigment Violets 1 (rhodamine lake), 3, 5:1, 16, 19 (quinacridone red), 23, and 38; and C.I. Pigment Blues 1, 2, 15 (phthalocyanine blue R), 15:1, 15:2, 15:3 (phthalocyanine blue G), 15:4, 15:6 (phthalocyanine blue E), 16, 17:1, 56, 60, and 63.

The average particle size of the pigment is preferably, but is not limited to, 25 μm or less, and more preferably 2 μm or less. The use of a pigment having an average particle size of 25 μm suppresses clogging and thus allows the ink composition to be more stably discharged.

Preferably, the pigment content in the ink composition is preferably 0.5% to 15% by mass, more preferably 1.0% to 10.0% by mass.

The pigment may be dispersed with a water-soluble resin. Examples of the water-soluble resin include, but are not limited to, polyvinyl alcohols, polyvinyl pyrrolidones, polyacrylic acid, acrylic acid-acrylonitrile copolymer, vinyl acetate-acrylic ester copolymer, acrylic acid-acrylic ester copolymer, styrene-acrylic acid copolymer, styrene-methacrylic acid copolymer, styrene-methacrylic acid-acrylic ester copolymer, styrene-α-methylstyrene-acrylic acid copolymer, styrene-α-methylstyrene-acrylic acid-acrylic ester copolymer, styrene-maleic acid copolymer, styrene-maleic anhydride copolymer, vinyl naphthalene-acrylic acid copolymer, vinyl naphthalene-maleic acid copolymer, vinyl acetate-maleic acid ester copolymer, vinyl acetate-crotonic acid copolymer, vinyl acetate-acrylic acid copolymer, and their salts. Among these, preferred are copolymers of a monomer having a hydrophobic functional group and a monomer having a hydrophilic functional group, and polymers formed of a monomer having both a hydrophobic functional group and a hydrophilic functional group. If a copolymer is used, the copolymer may be a random copolymer, a block copolymer, an alternating copolymer, or a graft copolymer.

The above-mentioned salts used for dispersing the pigment are not particularly limited, and may be formed with a basic compound, such as ammonia, ethylamine, diethylamine, triethylamine, propylamine, isopropylamine, dipropylamine, butylamine, isobutylamine, diethanolamine, triethanolamine, triisopropanolamine, aminomethylpropanol, or morpholine. The amount of the basic compound added is not limited as long as it is equal to or more than the neutralization equivalent of the water-soluble resin.

A commercially available water-soluble resin may be used to disperse the pigment. Examples of the commercially available resin dispersant include JONCRYL 67 (weight average molecular weight: 12,500, acid value: 213), JONCRYL 678 (weight average molecular weight: 8,500, acid value: 215), JONCRYL 586 (weight average molecular weight: 4,600, acid value: 108), JONCRYL 611 (weight average molecular weight: 8,100, acid value: 53), JONCRYL 680 (weight average molecular weight: 4,900, acid value: 215), JONCRYL 682 (weight average molecular weight: 1,700, acid value: 238), JONCRYL 683 (weight average molecular weight: 8,000, acid value: 160), and JONCRYL 690 (weight average molecular weight: 16,500, acid value: 240), which are all products of BASF Japan.

The pigment may be dispersed with a surfactant. Examples of the surfactant include, but are not limited to, anionic surfactants, such as alkane sulfonates, α-olefin sulfonates, alkylbenzene sulfonates, alkylnaphthalene sulfonates, acylmethyl taurinates, dialkyl sulfosuccinates, alkyl sulfates, sulfated olefins, polyoxyethylene alkyl ether sulfates, alkylphosphates, polyoxyethylene alkyl ether phosphates and monoglyceride phosphates; amphoteric surfactants, such as alkylpyridium salts, alkylamino acid salts and alkyldimethylbetaine; and nonionic surfactants, such as polyoxyethylene alkyl ethers, polyoxyethylene alkylphenyl ethers, polyoxyethylene alkyl esters, polyoxyethylene alkyl amides, glycerol alkyl esters and sorbitan alkyl esters.

The content of the water-soluble resin or surfactant that may be used for dispersing the pigment is preferably 1% to 100% by mass, and more preferably 5% to 50% by mass. Such an amount of water-soluble resin or surfactant allows the pigment to be stably dispersed in water. A hydrophilic functional group may be chemically or physically introduced to the surfaces of the pigment particles so that the pigment particles can be easily dispersed or dissolved.

### Surfactant

The ink composition may contain another surfactant such as silicone surfactant. Polysiloxane compounds are preferred silicone surfactants. For example, a polyether-modified organosiloxane may be used. Commercially available silicone surfactants may be used such as BYK-306, BYK-307, BYK-333, BYK-341, BYK-345, BYK-346, and BYK-348 (each a product of BYK); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (each a produce of Shin-Etsu Chemical Co., Ltd.).

### Water

Preferably, the water is pure water or ultra pure water from which ionic impurities have been removed as much as possible. Examples of such water include ion exchanged water, ultrafiltered water, reverse osmosis water, and distilled water. Preferably, sterile water prepared by, for example, UV irradiation or addition of hydrogen peroxide is used. The use of sterile water can prevent, for a long time, the occurrence of mold or bacteria in the pigment dispersion and the ink composition containing the pigment dispersion.

### Other Constituents

The ink composition may further contain a pH adjuster, a preservative or a fungicide, a rust preventive, a chelating agent and other additives.

Examples of the pH adjuster include, but are not limited to, potassium dihydrogenphosphate, disodium hydrogenphosphate, sodium hydroxide, lithium hydroxide, potassium hydroxide, ammonia, diethanolamine, triethanolamine, triisopropanolamine, potassium carbonate, sodium carbonate, and sodium hydrogencarbonate.

Examples of the preservative or fungicide include, but are not limited to, sodium benzoate, sodium pentachlorophenol, sodium 2-pyridinethiol-1-oxide, sodium sorbate, sodium dehydroacetate, and 1,2-dibenzisothiazolin-3-one. Commercially available preservatives or fungicides include Proxel XL2 and Proxel GXL (each a product of Avecia), and Denicide CSA and NS-500W (each a product of Nagase Chemtex).

The rust preventive may be, but is not limited to, benzotriazole.

Examples of the chelating agent include, but are not limited to, ethylenediaminetetraacetic acid and its salts, such as disodium dihydrogen ethylenediaminetetraacetate.

### Physical Properties

Preferably, the ink composition used in the recording method of the present embodiment has a viscosity of 2 to 10 mPa·s, more preferably 3 to 8 mPa·s, at 20° C. When the ink composition has a viscosity in such a range at 20° C., nozzles can eject the ink composition in a droplet form having an appropriate size, and the deviation or scattering of droplets can be reduced. Therefore, such an ink composition is suitable for use in recording apparatuses. The viscosity of the ink composition can be measured with a vibration viscometer VM-100AL (manufactured by Yamaichi Electronics) with the ink composition kept at 20° C.

### EXAMPLES

The invention will be further described in detail with reference to Examples and Comparative Examples. However, the invention is not limited to the following Examples.

### Preparation of Recording Medium

A coating liquid prepared in a following process was applied onto a base layer (transparent PET film having a thickness of 100 μm) at a thickness of 20 μm by hand coating, followed by drying at 80° C. for 5 minutes. Thus, recording media (Samples A to H) each having an ink receiving layer were prepared.

### Ink Receiving Layer

Acrylic polymers were synthesized from the following acrylic monomers. To a mixture of methyl methacrylate (hereinafter designated as MMA), butyl acrylate (hereinafter designated as BA) and ethyl acrylate (hereinafter designated as EA) in proportions shown in Table 1, each produced by Mitsubishi Chemical, 40 parts by mass of water and surfactants (1 part of Neoplex G-65 and 2 parts of EMULGEN 1118S-70) were added. Then, 2 parts of an aqueous polyester (NEWTLAC 2010) was dropped to the mixture at 75° C. in a reaction vessel equipped with a stirrer, a cooler, a thermometer and a dropping funnel over a period of 1 hour, and thus a polymerization reaction was promoted to yield an aqueous dispersion. The above amounts of the constituents were each represented in a mass basis relative to 100% by mass of the mixture.

An aqueous urethane emulsion (any one of Taisei Fine Chemical Urethane emulsion series WBR-2101, WBR-2000U and WBR-2018 hereinafter, designated as UE) was added to the aqueous dispersion so that the ratio of the solid contents in the aqueous dispersion to the solid content in the aqueous urethane resin emulsion would be 1:1. The mixture was stirred at 40° C. for 5 hours to yield a coating liquid for the ink receiving layer.

### Ink Composition

### Pigments

C, M, Y and K ink compositions were used, each in which the corresponding pigment was dispersed.

C: cyan ink composition, containing C.I. Pigment Blue 15:3

M: magenta ink composition, containing C.I. Pigment Red 122

Y: yellow ink composition, containing C.I. Pigment Yellow 180

K: black ink composite, containing C.I. Pigment Black 7

### Preparation

Ink Compositions 1 were prepared as below. First, ion exchanged water was added to 5.0% by mass of a thermoplastic saturated copolymer polyester resin (glass transition temperature Tg₁: 80° C., Elitel KA 3556 produced by Unitika) acting as a resin dispersant and 20% by mass of a pigment (any one of the above pigments) to a total of 100% by mass, followed by mixing and stirring to yield a mixture. The resulting mixture sufficiently blended for 6 hours with zirconia beads of 1.5 mm in diameter in a sand mill (manufactured by Yasukawa Seisakusho). Then, the zirconia beads were removed with a separator to yield a pigment dispersion.

To 7% by mass of the pigment dispersion were added 3% by mass of a first solvent 1,2-hexanediol, 7% by mass of a second solvent containing 1,3-dimethyl-2-imidazolidinone and 2-pyrrolidone, 0.5% by mass of a silicone surfactant polyether-modified siloxane, and a balance of ion exchanged water to a total of 100% by mass. Then, the mixture was stirred for 1 hour at room temperature, and filtered through a membrane filter of 5 μm in pore size. Thus, Ink Compositions 1 of four colors C, M, Y and K were prepared.

Ink Compositions 2 of four colors C, M, Y and K were prepared in the same manner as Ink Compositions 1, except that Eliter KA 1449 (glass transition temperature Tg₁: 40° C., produced by Unitika) was used as a thermoplastic saturated copolymer polyester resin instead of Eliter KA 3556.

### Examples 1 to 27, Comparative Examples 1 to 11

### Discharging of Ink Composition (First Step)

An ink jet printer PX-G930 (manufactured by Seiko Epson) was altered so as to be equipped at a paper guide with a heater capable of varying temperature so that the recording medium can be heated during recording.

The nozzle line of the altered ink jet printer was charged with Ink Compositions 1 or 2 of four colors C, M, Y and K. Images of a solid pattern were formed on the recording media prepared above at room temperature and normal pressure in such a manner that C, M, Y and K colors came into contact with each other while the recording medium was heated to a surface temperature Tm of 30, 40, 45 or 55° C. with the heater provided at the paper guide (Examples 1 to 27 and Comparative Examples 1 to 11). Ink Compositions 1 were used in Examples 1 to 21 and 26 and Comparative Examples 1 to 11, and Ink Compositions 2 were used in Examples 22 to 25 and 27.

### Heating of Recording Medium (Second Step)

After the discharging of the ink composition, the recording medium was placed in a dryer kept at 90° C. (second step temperature) and the solid pattern image was further dried for 2 minutes. Thus a recorded article was prepared in which the solid pattern image was printed on the recording medium. The solid pattern image was formed so that it would have a vertical resolution of 1440 dots per inch (dpi) and a horizontal resolution of 720 dpi, and a duty of 10% to 200%. Each of the resulting recorded articles was evaluated for ink aggregation, cracks, roller mark unevenness, and tub fastness, according to the criteria described below. Incidentally, the second step temperature in Example 26 was set at 70° C., and the second step temperature in Example 27 was set at 30° C. The results are shown in Tables 1 to 8.

### Definition of Duty

The term “duty” mentioned herein refers to the ratio in percentage of the number of segments filled with ink. For example, when the resolution is 1440 dpi by 720 dpi, the duty in this case refers to the ratio in percentage of the number of segments filled with ink to the number of segments of 1036800 (1440 by 720) in an area of 1 square inch. Recording operations in the Examples and Comparative Examples were performed at the same printing speed, and recording conditions were as follows:
The weight of each ink droplet was adjusted to about 15 ng.
Solid patterns were formed at duties in the range of 10% to 100% in increments of 10% (primary colors CMYK).
Solid patterns were formed at duties in the range of 10% to 200% in increments of 10% (secondary colors RGB).

### Aggregation

Image quality in aggregation was visually evaluated for 1440 dpi×720 dpi printing according to the following criteria. The term “aggregation” means that dots of an ink having landed on a recording medium are mixed with each other. Such aggregation degrades image quality.

### Evaluation Criteria

Excellent: Aggregation did not occur at a duty of 200%.

Good: Aggregation occurred at a duty of 110% to 190%.

Fair: Aggregation occurred at a duty of 60% to 100%.

Bad: Aggregation occurred at a duty of 10% to 50%.

### Cracks

Image quality in cracks was visually evaluated for 1440 dpi×720 dpi printing according to the following criteria. The term “cracks” refers to one or more cracks in an image, formed by shrinkage of the ink coating of an ink composition on a recording medium. Such cracks degrade image quality.

### Evaluation Criteria

Excellent: No Crack occurred at a duty of 200%.

Good: One or more cracks occurred at a duty of 110% to 190%.

Fair: One or more cracks occurred at a duty of 60% to 100%.

Bad: One or more cracks occurred at a duty of 10% to 50%.

### Roller Mark Unevenness

Image quality in roller mark unevenness was visually evaluated for 1440 dpi×720 dpi printing according to the following criteria. The term “roller mark unevenness” mentioned herein refers to an uneven state in which marks of rubber rollers (of urethane, elastomer or plastic) disposed for holding paper in the paper feeding path of a printer are formed in a portion on which the ink composition is deposited, or a phenomenon in which the ink composition is repelled or spread. When a hydrophobic paper sheet or the like is fed, the hydrophobic material of the paper sheet may be transferred to the rollers and subsequently transferred to the paper sheet again from the rollers. Probably, the portion of the paper sheet to which the hydrophobic material has been transferred rejects water or the solvent in the ink composition, and this rejection causes roller mark unevenness.

### Evaluation Criteria

Good: Roller mark unevenness was not observed.

Bad: Roller mark unevenness was observed.

Rub Fastness

The surface of the resulting recorded article on which the image was formed was rubbed 10 times at a load of 500 g within 30 minutes after printing and drying with a rubber with a white cotton rubbing cloth, using a Gakushin-type rubbing tester AB-301 (manufactured by Tester Sangyo). Then, the surface of the image was visually observed and evaluated according to the following criteria.

### Evaluation Criteria

Good: No flaw was observed after rubbing the surface 10 times.

Bad: A flaw exposing an underlayer was observed after rubbing the surface 10 times.

### Measurement of Tg₂ of Rein in Ink Receiving Layer

Each of the acrylic-urethane resin emulsions used for the ink receiving layers was evaporated to remove the solvent by heating in a 60° C. thermostatic bath. The resulting sample was pinched in the thickness direction with an aluminum circular jig of 25 mm in diameter so that the thickness of the sample became about 2 mm, and was then placed at a predetermined position of a rotational rheometer ARES (ARES-G2 series, manufactured by TA Instruments). The elastic deformation and viscous deformation of the resin of the sample were measured by the rotational rheometer ARES with a strain of 0.5% applied at temperatures in the range of −10 to 250° C., a heat-up rate of 5° C./min, and a frequency of 1 Hz, and the glass transition temperature Tg₂ was obtained from the inflection point of the temperature dependence of these deformations.

TABLE 1

| | | | | | | | | | | | Tm: 30° C., Tg1: 80° C., Second | | | |
|---|---|---|---|---|---|---|---|---|---|---|---|---|---|---|
| | | Composition and property of ink receiving layer | | | | | | | | | step temperature: 90° C. | | | |
| | | | | | Neoplex | Emulgen | Newtlac | | | | | | | Rub |
| | Recording | MMA | BA | EA | G-65 | 1118S-70 | 2010 | UE | Tg₂ | Urethane | Aggre- | | Roller | fast- |
| | medium | (parts) | (parts) | (parts) | (parts) | (parts) | (parts) | (parts) | (° C.) | skeleton | gation | Crack | marks | ness |
| Comparative | Sample A | 40 | 8 | 2 | 1 | 2 | 2 | 45 | 12 | Poly | Bad | Excel- | Bad | Good |
| Example 1 | | | | | | | | | | carbonate | | lent | | |
| Comparative | Sample B | 40 | 8 | 2 | 1 | 2 | 2 | 45 | 15 | Polyether | Good | Excel- | Bad | Good |
| Example 2 | | | | | | | | | | | | lent | | |
| Comparative | Sample C | 33 | 14 | 3 | 1 | 2 | 2 | 45 | 20 | Polyether | Fair | Excel- | Bad | Good |
| Example 3 | | | | | | | | | | | | lent | | |
| Comparative | Sample D | 27 | 18 | 5 | 1 | 2 | 2 | 45 | 30 | Polyester | Bad | Fair | Good | Good |
| Example 4 | | | | | | | | | | | | | | |
| Comparative | Sample E | 24 | 20 | 6 | 1 | 2 | 2 | 45 | 35 | Polyether | Good | Excel- | Bad | Good |
| Example 5 | | | | | | | | | | | | lent | | |
| Comparative | Sample F | 24 | 20 | 6 | 1 | 2 | 2 | 45 | 42 | Poly- | Fair | Excel- | Good | Good |
| Example 6 | | | | | | | | | | carbonate | | lent | | |
| Comparative | Sample G | 20 | 20 | 10 | 1 | 2 | 2 | 45 | 47 | Poly | Fair | Excel- | Good | Good |
| Example 7 | | | | | | | | | | carbonate | | lent | | |
| Comparative | Sample H | 20 | 20 | 10 | 1 | 2 | 2 | 45 | 55 | Polyester | Fair | Fair | Good | Good |
| Example 8 | | | | | | | | | | | | | | |

TABLE 2

| | | | | | | | | | | | Tm: 40° C., Tg1: 80° C., Second step | | | |
|---|---|---|---|---|---|---|---|---|---|---|---|---|---|---|
| | | Composition and property of ink receiving layer | | | | | | | | | temperature: 90° C. | | | |
| | | | | | Neoplex | Emulgen | Newtlac | | | | | | | Rub |
| | Recording | MMA | BA | EA | G-65 | 1118S-70 | 2010 | UE | Tg₂ | Urethane | Aggre- | | Roller | fast- |
| | medium | (parts) | (parts) | (parts) | (parts) | (parts) | (parts) | (parts) | (° C.) | skeleton | gation | Crack | marks | ness |
| Com- | Sample A | 40 | 8 | 2 | 1 | 2 | 2 | 45 | 12 | Poly- | Bad | Good | Bad | Good |
| parative | | | | | | | | | | carbonate | | | | |
| Example 9 | | | | | | | | | | | | | | |
| Example 1 | Sample B | 40 | 8 | 2 | 1 | 2 | 2 | 45 | 15 | Polyether | Good | Good | Bad | Good |
| Example 2 | Sample C | 33 | 14 | 3 | 1 | 2 | 2 | 45 | 20 | Polyether | Good | Excel- | Bad | Good |
| | | | | | | | | | | | | lent | | |
| Example 3 | Sample D | 27 | 18 | 5 | 1 | 2 | 2 | 45 | 30 | Polyester | Fair | Fair | Good | Good |
| Example 4 | Sample E | 24 | 20 | 6 | 1 | 2 | 2 | 45 | 35 | Polyether | Good | Good | Bad | Good |
| Example 5 | Sample F | 24 | 20 | 6 | 1 | 2 | 2 | 45 | 42 | Poly- | Good | Fair | Good | Good |
| | | | | | | | | | | carbonate | | | | |
| Example 6 | Sample G | 20 | 20 | 10 | 1 | 2 | 2 | 45 | 47 | Poly- | Excellent | Good | Good | Good |
| | | | | | | | | | | carbonate | | | | |
| Example 7 | Sample H | 20 | 20 | 10 | 1 | 2 | 2 | 45 | 55 | Polyester | Excellent | Fair | Good | Good |

TABLE 3

| | | | | | | | | | | | Tm: 45° C., Tg1: 80° C., Second | | | |
|---|---|---|---|---|---|---|---|---|---|---|---|---|---|---|
| | | Composition and property of ink receiving layer | | | | | | | | | step temperature: 90° C. | | | |
| | | | | | Neoplex | Emulgen | Newtlac | | | | | | | Rub |
| | Recording | MMA | BA | EA | G-65 | 1118S-70 | 2010 | UE | Tg₂ | Urethane | Aggre- | | Roller | fast- |
| | medium | (parts) | (parts) | (parts) | (parts) | (parts) | (parts) | (parts) | (° C.) | skeleton | gation | Crack | marks | ness |
| Com- | Sample A | 40 | 8 | 2 | 1 | 2 | 2 | 45 | 12 | Poly- | Fair | Good | Bad | Good |
| parative | | | | | | | | | | carbonate | | | | |
| Example | | | | | | | | | | | | | | |
| 10 | | | | | | | | | | | | | | |
| Example 8 | Sample B | 40 | 8 | 2 | 1 | 2 | 2 | 45 | 15 | Polyether | Good | Good | Bad | Good |
| Example 9 | Sample C | 33 | 14 | 3 | 1 | 2 | 2 | 45 | 20 | Polyether | Good | Excel- | Bad | Good |
| | | | | | | | | | | | | lent | | |
| Example | Sample D | 27 | 18 | 5 | 1 | 2 | 2 | 45 | 30 | Polyester | Fair | Fair | Good | Good |
| 10 | | | | | | | | | | | | | | |
| Example | Sample E | 24 | 20 | 6 | 1 | 2 | 2 | 45 | 35 | Polyether | Good | Good | Bad | Good |
| 11 | | | | | | | | | | | | | | |
| Example | Sample F | 24 | 20 | 6 | 1 | 2 | 2 | 45 | 42 | Poly- | Good | Good | Good | Good |
| 12 | | | | | | | | | | carbonate | | | | |
| Example | Sample G | 20 | 20 | 10 | 1 | 2 | 2 | 45 | 47 | Poly | Excellent | Good | Good | Good |
| 13 | | | | | | | | | | carbonate | | | | |
| Example | Sample H | 20 | 20 | 10 | 1 | 2 | 2 | 45 | 55 | Polyester | Excellent | Good | Good | Good |
| 14 | | | | | | | | | | | | | | |

TABLE 4

| | | | | | | | | | | | Tm: 55° C., Tg1: 80° C., Second | | | |
|---|---|---|---|---|---|---|---|---|---|---|---|---|---|---|
| | | Composition and property of ink receiving layer | | | | | | | | | step temperature: 90° C. | | | |
| | | | | | Neoplex | Emulgen | Newtlac | | | | | | | Rub |
| | Recording | MMA | BA | EA | G-65 | 1118S-70 | 2010 | UE | Tg₂ | Urethane | Aggre- | | Roller | fast- |
| | medium | (parts) | (parts) | (parts) | (parts) | (parts) | (parts) | (parts) | (° C.) | skeleton | gation | Crack | marks | ness |
| Com- | Sample A | 40 | 8 | 2 | 1 | 2 | 2 | 45 | 12 | Poly- | Fair | Good | Bad | Good |
| parative | | | | | | | | | | carbonate | | | | |
| Example | | | | | | | | | | | | | | |
| 11 | | | | | | | | | | | | | | |
| Example | Sample B | 40 | 8 | 2 | 1 | 2 | 2 | 45 | 15 | Polyether | Excellent | Excel- | Bad | Good |
| 15 | | | | | | | | | | | | lent | | |
| Example | Sample C | 33 | 14 | 3 | 1 | 2 | 2 | 45 | 20 | Polyether | Excellent | Excel- | Bad | Good |
| 16 | | | | | | | | | | | | lent | | |
| Example | Sample D | 27 | 18 | 5 | 1 | 2 | 2 | 45 | 30 | Polyester | Excellent | Fair | Good | Good |
| 17 | | | | | | | | | | | | | | |
| Example | Sample E | 24 | 20 | 6 | 1 | 2 | 2 | 45 | 35 | Polyether | Excellent | Excel- | Bad | Good |
| 18 | | | | | | | | | | | | | lent | |
| Example | Sample F | 24 | 20 | 6 | 1 | 2 | 2 | 45 | 42 | Poly- | Excellent | Excel- | Good | Good |
| 19 | | | | | | | | | | carbonate | | lent | | |
| Example | Sample G | 20 | 20 | 10 | 1 | 2 | 2 | 45 | 47 | Poly- | Excellent | Excel- | Good | Good |
| 20 | | | | | | | | | | carbonate | | lent | | |
| Example | Sample H | 20 | 20 | 10 | 1 | 2 | 2 | 45 | 55 | Polyester | Excellent | Good | Good | Good |
| 21 | | | | | | | | | | | | | | |

TABLE 5

| | | | | | | | | | | | Tm: 55° C., | | | |
|---|---|---|---|---|---|---|---|---|---|---|---|---|---|---|
| | | | | | | | | | | | Tg1: 40° C., Second | | | |
| | | Composition and property of ink receiving layer | | | | | | | | | step temperature: 90° C. | | | |
| | | | | | Neoplex | Emulgen | Newtlac | | | | | | | Rub |
| | Recording | MMA | BA | EA | G-65 | 1118S-70 | 2010 | UE | Tg₂ | Urethane | Aggre- | | Roller | fast- |
| | medium | (parts) | (parts) | (parts) | (parts) | (parts) | (parts) | (parts) | (° C.) | skeleton | gation | Crack | marks | ness |
| Example | Sample G | 20 | 20 | 10 | 1 | 2 | 2 | 45 | 47 | Polycarbonate | Good | Fair | Good | Bad |
| 22 | | | | | | | | | | | | | | |
| Example | Sample H | 20 | 20 | 10 | 1 | 2 | 2 | 45 | 55 | Polyester | Good | Good | Good | Bad |
| 23 | | | | | | | | | | | | | | |

TABLE 6

| | | | | | | | | | | | Tm: 45° C., | | | |
|---|---|---|---|---|---|---|---|---|---|---|---|---|---|---|
| | | | | | | | | | | | Tg1: 40° C., Second | | | |
| | | Composition and property of ink receiving layer | | | | | | | | | step temperature: 90° C. | | | |
| | | | | | Neoplex | Emulgen | Newtlac | | | | | | | Rub |
| | Recording | MMA | BA | EA | G-65 | 1118S-70 | 2010 | UE | Tg₂ | Urethane | Aggre- | | Roller | fast- |
| | medium | (parts) | (parts) | (parts) | (parts) | (parts) | (parts) | (parts) | (° C.) | skeleton | gation | Crack | marks | ness |
| Example | Sample G | 20 | 20 | 10 | 1 | 2 | 2 | 45 | 47 | Polycarbonate | Good | Good | Good | Bad |
| 24 | | | | | | | | | | | | | | |
| Example | Sample H | 20 | 20 | 10 | 1 | 2 | 2 | 45 | 55 | Polyester | Good | Fair | Good | Bad |
| 25 | | | | | | | | | | | | | | |

TABLE 7

| | | | | | | | | | | | Tm: 45° C., | | | |
|---|---|---|---|---|---|---|---|---|---|---|---|---|---|---|
| | | | | | | | | | | | Tg1: 80° C., Second | | | |
| | | Composition and property of ink receiving layer | | | | | | | | | step temperature: 70° C. | | | |
| | | | | | Neoplex | Emulgen | Newtlac | | | | | | | Rub |
| | Recording | MMA | BA | EA | G-65 | 1118S-70 | 2010 | UE | Tg₂ | Urethane | Aggre- | | Roller | fast- |
| | medium | (parts) | (parts) | (parts) | (parts) | (parts) | (parts) | (parts) | (° C.) | skeleton | gation | Crack | marks | ness |
| Example | Sample G | 20 | 20 | 10 | 1 | 2 | 2 | 45 | 47 | Polycarbonate | Good | Good | Good | Bad |
| 26 | | | | | | | | | | | | | | |

TABLE 8

| | | | | | | | | | | | Tm: 45° C., | | | |
|---|---|---|---|---|---|---|---|---|---|---|---|---|---|---|
| | | | | | | | | | | | Tg1: 40° C., Second | | | |
| | | Composition and property of ink receiving layer | | | | | | | | | step temperature: 30° C. | | | |
| | | | | | Neoplex | Emulgen | Newtlac | | | | | | | Rub |
| | Recording | MMA | BA | EA | G-65 | 1118S-70 | 2010 | UE | Tg₂ | Urethane | Aggre- | | Roller | fast- |
| | medium | (parts) | (parts) | (parts) | (parts) | (parts) | (parts) | (parts) | (° C.) | skeleton | gation | Crack | marks | ness |
| Example | Sample G | 20 | 20 | 10 | 1 | 2 | 2 | 45 | 47 | Polycarbonate | Good | Good | Good | Bad |
| 27 | | | | | | | | | | | | | | |

The results of the evaluations show that when ink compositions were discharged onto a recording medium having a surface temperature Tm of less than 40° C. and including an ink receiving layer containing a resin having a glass transition temperature Tg₂ outside the range of 15 to 55° C., aggregation occurred and image quality was degraded. It has been also shown that the higher the glass transition temperature Tg₁, the better the rub fastness, and that the higher the second step temperature, the better the rub fastness.

As described above, the recording method of the disclosed embodiments reduces ink aggregation even if the amount of ejected ink is increased to improve image quality.

It will be appreciated that the invention is not limited to the above-disclosed embodiments, and that various modifications may be made without departing from the spirit and scope of the invention.

The entire disclosure of Japanese Patent Application No. 2012-247808, filed Nov. 9, 2012 is expressly incorporated by reference herein.

What is claimed is:

1. A recording method comprising:
discharging an ink composition containing a resin having a glass transition temperature Tg₂ onto a recording medium having a surface temperature Tm of 40° C. or more, wherein the recording medium includes an ink receiving layer containing a resin having a glass transition temperature Tg₂ of 15 to 55° C.

2. The recording method according to claim 1, wherein the glass transition temperature Tg₂ is 40 to 55° C.

3. The recording method according to claim 1, wherein the ink receiving layer contains at least one of a urethane resin and an acrylic resin.

4. The recording method according to claim 3, wherein the ink receiving layer contains a polycarbonate-based urethane resin.

5. The recording method according to claim 1, wherein the glass transition temperature Tg₂ of the resin in the ink composition is more than 40° C.

6. The recording method according to claim 1, wherein the glass transition temperature Tg₂ of the resin in the ink composition, the surface temperature Tm and the glass transition temperature Tg₂ of the resin in the ink receiving layer satisfy the relationship: Tg₂>Tm≧Tg₂.

7. The recording method according to claim 1, further comprising heating the recording medium to a temperature.

8. The recording method according to claim 7, wherein the temperature in the heating is higher than or equal to the glass transition temperature Tg₂ of the resin in the ink composition.

9. The recording method according to claim 1, wherein the glass transition temperature Tg₂ of the resin in the ink composition is 70 to 120° C.

10. The recording method according to claim 1, wherein the ink composition contains at least one selected from the group consisting of 2-pyrrolidone, N,N′-dimethylpropyleneurea, 1,3-dimethylimidazolidinone, 1,2-pentanediol, 1,2-hexanediol, 1,2-heptanediol, triethylene glycol, 1,6-hexanediol, 2-methyl-2,4-pentanediol, 3-methyl-1,5-pentanediol, and 2-ethyl-1,3-hexanediol.
